(19) United States
(12) Patent Application Publication
(10) Pub. No.: US 2014/0153095 A1
(43) Pub. Date: Jun. 5, 2014

(54) POLARIZING PLATE HAVING PRESSURE-SENSITIVE ADHESIVE LAYER AND IMAGE DISPLAY DEVICE

(71) Applicant: NITTO DENKO CORPORATION, Osaka (JP)

(72) Inventors: Tsuyoshi Chiba, Osaka (JP); Masato Bito, Osaka (JP); Yuuji Miyaki, Osaka (JP)

(73) Assignee: NITTO DENKO CORPORATION, Osaka (JP)

(21) Appl. No.: 14/175,467

(22) Filed: Feb. 7, 2014

Related U.S. Application Data
(62) Division of application No. 13/166,873, filed on Jun. 23, 2011.

(51) Int. Cl. G02B 5/30

(52) U.S. Cl. CPC G02B 5/30
USPC 359/483.01

(57) ABSTRACT

Provided is a polarizing plate having pressure-sensitive adhesive layer, including a polarizer, a transparent protective film placed on at least one surface of the polarizer, and a pressure-sensitive adhesive layer placed on a surface of the transparent protective film on a side where the polarizer is not placed. The pressure-sensitive adhesive layer is formed from pressure-sensitive adhesive including acryl-based polymer including alkyl (meth)acrylate monomer unit and aromatic ring structure-containing (meth)acrylate monomer unit. The transparent protective film has an absolute value of photoelastic coefficient of 50×10⁻¹² (m²/N) or less, and X and Y satisfy the relation −1×10¹¹X+3≦Y≦−1×10¹¹X+23. X represents the photoelastic coefficient (m²/N) of the transparent protective film, and Y represents the content (%) of the aromatic ring structure-containing (meth)acrylate monomer unit in the acryl-based polymer.

### CROSS-REFERENCE TO RELATED APPLICATIONS

This application is a continuation of U.S. application Ser. No. 13/166,873, filed on Jun. 23, 2011, the entire contents of which are incorporated herein by reference.

### BACKGROUND OF THE INVENTION

1. Field of the Invention

The invention relates to a polarizing plate having pressure-sensitive adhesive layer in which a pressure-sensitive adhesive layer is placed on at least one surface of the polarizing plate and to an image display device produced therewith.

2. Description of the Related Art

A liquid crystal display is configured to include a combination of a light source such as a backlight and a liquid crystal panel including a liquid crystal cell and a polarizing plate placed on at least one side of the liquid crystal cell, in which the liquid crystal cell and the polarizing plate are generally bonded together with a pressure-sensitive adhesive layer interposed therebetween. An organic electroluminescence (EL) display is configured to include a cell and a circularly polarizing plate, which is bonded to the viewer side of the cell with a pressure-sensitive adhesive layer interposed therebetween so that specular reflection of external light can be blocked. When an image display device having such a polarizing plate is subjected to actual use, particularly, subjected to actual use in a high-temperature or high-humidity environment, light leakage may occur at an end portion of the screen.

It is considered that such light leakage associated with an environmental change can be caused by a change in the retardation of each component of the polarizing plate, in which the change is caused by the stress on the interface of each component, which has undergone a dimensional change due to the change in temperature, humidity or the like. Specifically, it is considered that in such a polarizing plate, which generally includes a polarizer and a transparent protective film placed on the polarizer with an adhesive layer interposed therebetween, the environmental change causes stress at the interface between the transparent protective film and the polarizer or at the interface of any other component bonded to the transparent protective film, so that photoelastic birefringence is caused by the stress to change the retardation properties of the transparent protective film, which may cause light leakage. In particular, light leakage tends to be significant at the end portion of the screen, because the dimensional change of each component is greater at the end portion of the screen than at the center of the screen.

In recent years, following a trend toward an increase in the size or brightness of image display devices, the temperature of the interior of image display devices tends to be high due to the generation of heat from light sources. The variety of uses for flat panel display devices such as liquid crystal displays and organic EL displays has also increased, so that the opportunity to use such devices in harsh environments such as high-temperature or high-humidity environments tends to increase. Therefore, light leakage associated with an environmental change becomes more likely to be observed at end portions of screens.

In order to suppress such light leakage at end portions of screens, Japanese Patent Application Laid-Open (JP-A) No. 2000-352619 proposes that a transparent protective film with a small absolute value of photoelastic coefficient should be used so that the change in the retardation of the transparent protective film can be small. JP-A No. 2008-217021 proposes that the difference between the tensile elastic modulus in the machine direction and that in a direction perpendicular to the machine direction should be reduced during the process of manufacturing a transparent protective film. JP-A Nos. 2002-122739 and 2002-122740 propose methods in which the product of the linear expansion coefficient of a transparent protective film and the elastic modulus of a pressure-sensitive adhesive layer should be in the specified range so that the change in the retardation of the transparent protective film can be small.

### SUMMARY OF THE INVENTION

As disclosed in JP-A No. 2000-352619, the environment-induced change in the retardation of a transparent protective film should be made small so that light leakage at end portions of screens can be suppressed. From this point of view, the absolute value of the photoelastic coefficient of the transparent protective film should preferably be small, and it may be considered that theoretically, the problem of light leakage may be solved using a transparent protective film with a photoelastic coefficient of substantially zero. As a result of a study by the inventors, however, it has been revealed that even when a transparent protective film with a small absolute value of photoelastic coefficient is used, usage environment-induced light leakage occurs at end portions of screens.

Under the circumstances described above, an object of the invention is to provide a polarizing plate having pressure-sensitive adhesive layer (referred as “pressure-sensitive adhesive-type polarizing plate”, hereafter) capable of forming an image display device that resists light leakage even under a change in usage environment, and to provide an image display device produced with such a pressure-sensitive adhesive-type polarizing plate.

The inventors have conducted a study on why light leakage occurs even when a transparent protective film with a small photoelastic coefficient is used. As a result, the inventors have newly found that the level of light leakage varies with the type of the pressure-sensitive adhesive layer used to bond a polarizing plate and a liquid crystal cell together. This finding has allowed the inventors to make a dedicated study based on the presumed principle that the usage environment-induced light leakage in image display devices may be caused not only by a change in the retardation of a transparent protective film but also by the occurrence of a retardation in a pressure-sensitive adhesive layer. As a result, the inventors have accomplished the invention based on the finding that a specific combination of a transparent protective film and an adhesive layer can suppress the light leakage.

The invention relates to a polarizing plate having a pressure-sensitive adhesive layer. The polarizing plate includes a polarizer and a transparent protective film placed on at least one surface of the polarizer, and a pressure-sensitive adhesive layer placed on a surface of the transparent protective film on a side where the polarizer is not placed. The pressure-sensitive adhesive layer includes a pressure-sensitive adhesive including an acryl-based polymer. The acryl-based polymer includes an alkyl (meth)acrylate monomer unit and an aromatic ring structure-containing (meth)acrylate monomer unit.

The transparent protective film has an absolute value of photoelastic coefficient of 50×10⁻¹² (m²/N) or less. In addition the transparent protective film satisfies the formula −1×10¹¹X+3≦Y≦−1×10¹¹X+23. In the formula, X represents the photoelastic coefficient (m²/N) of the transparent protective film, and Y represents the content (%) of the aromatic ring structure-containing (meth)acrylate monomer unit in the acryl-based polymer.

In the polarizer of the invention, the transparent protective film preferably includes at least one resin selected from the group consisting of an acrylic resin, a cyclic olefin resin, a phenylmaleimide resin, a cellulose resin, and a modified polycarbonate resin.

The invention also relates to an image display device including the polarizing plate having pressure-sensitive adhesive layer.

In the polarizing plate of the invention, the acryl-based polymer, which forms the pressure-sensitive adhesive layer, contains the specified amount of the aromatic ring structure-containing (meth)acrylate monomer unit (component B). The content Y of the component B is determined depending on the value of the photoelastic coefficient X of the transparent protective film and is controlled so that the pressure-sensitive adhesive layer can produce a retardation change of an opposite sign to that of a change in the retardation of the transparent protective film when the retardation of the transparent protective film is changed by an environmental change such as heating.

According to this feature, the change in the retardation of the pressure-sensitive adhesive layer is also relatively large in the vicinity of the end of the screen where the change in the retardation of the transparent protective film is relatively large (in which the sign of the change in the retardation of the pressure-sensitive adhesive layer is opposite to the sign of the change in the retardation of the transparent protective film), so that the change in the retardation of the transparent protective film and the change in the retardation of the pressure-sensitive adhesive layer compensate each other in the entire surface of the pressure-sensitive adhesive-type polarizing plate. Thus, the image display device with the polarizing plate of the invention bonded therein can display images with reduced light leakage even when exposed to a heating environment or the like.

### BRIEF DESCRIPTION OF DRAWINGS

FIG. 1 is a schematic cross-sectional view of a polarizing plate having pressure-sensitive adhesive layer according to an embodiment of the invention; and

FIG. 2 is a schematic cross-sectional view of an image display device according to an embodiment of the invention.

### DETAILED DESCRIPTION OF THE PREFERRED EMBODIMENTS

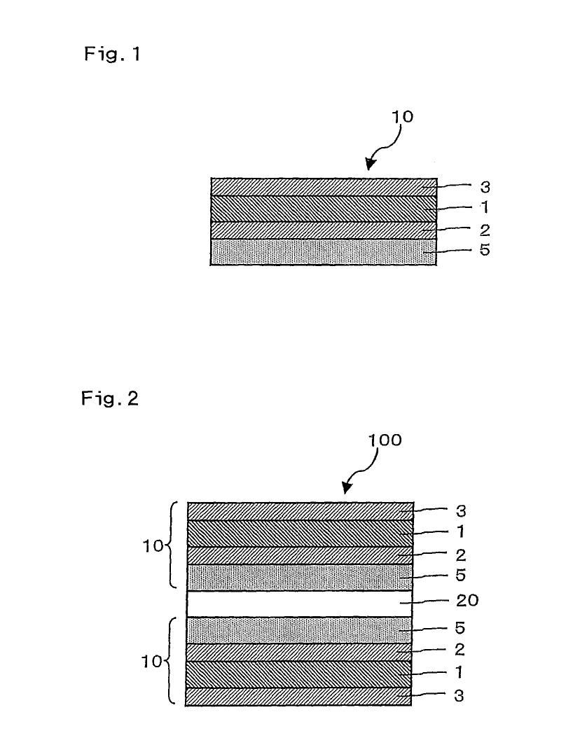

The invention is described below with reference to the drawings. As shown in FIG. 1, a polarizing plate 10 according to an embodiment of the invention includes a polarizer 1, a first transparent protective film 2 provided on one side of the polarizer 1, and a pressure-sensitive adhesive layer 5 provided on the transparent protective film 2. The polarizer 1 and the first transparent protective film 2 are adhered with an adhesive layer (not shown) interposed therebetween. A second transparent protective film 3 is preferably placed on the opposite side of the polarizer 1 from the side on which the first transparent protective film 2 is placed, wherein an adhesive layer (not shown) is interposed between the second transparent protective film 3 and the polarizer 1.

When the polarizing plate 10 according to an embodiment of the invention is used to form an image display device 100, the surface on the side where the first transparent protective film 2 is placed is bonded as shown in FIG. 2 to an image display cell 20 with the pressure-sensitive adhesive layer 5 interposed therebetween. Namely, the first transparent protective film 2 and the pressure-sensitive adhesive layer 5 are placed between the image display cell 20 and the polarizer 1. While FIG. 2 shows that the pressure-sensitive adhesive-type polarizing plates 10 are bonded to both surfaces of the image display cell 20, the pressure-sensitive adhesive-type polarizing plate may be bonded to only one surface of the image display cell 20.

### Polarizer

A polarizer 1 is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol based film, partially formalized polyvinyl alcohol based film, and ethylene-vinyl acetate copolymer based partially saponified film; poly-ene based oriented films, such as dehydrated polyvinyl alcohol and dehydrochlorinated polyvinyl chloride, etc. may be mentioned. Among these, a polyvinyl alcohol based film with dichromatic materials such as iodine is suitably used. A thickness of polarizer is not especially limited, but the thickness of about 5 to 80 μm is commonly adopted.

A polarizer that is uniaxially stretched after a polyvinyl alcohol based film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol based film may be dipped in water and rinsed if needed. By rinsing polyvinyl alcohol based film with water, soils and anti-blocking agent on the polyvinyl alcohol based film surface may be washed off. In addition, uniformity, such as unevenness of dyeing, may be prevented by making polyvinyl alcohol based film swelled. Stretching may be performed after dyed with iodine or may be performed concurrently, or conversely dyeing with iodine may be performed after stretching. Stretching may be performed in aqueous solutions, such as boric acid and potassium iodide or in a water bath.

### Transparent Protective Film

The first transparent protective film 2 placed on one main surface of the polarizer has an absolute value of photoelastic coefficient of 50×10⁻¹² m²/N or less. If the photoelastic coefficient is too large, any stress applied to the first protective film may tend to cause unevenness in image display. The photoelastic coefficient may be determined from the gradient of a plot of stress against the retardation value measured when a certain tension is applied to the film. The sign of the photoelastic coefficient is defined as being positive when the retardation is increased by the application of tensile stress, and it is defined as being negative when the retardation is decreased by the application of tensile stress.

### (Materials for Transparent Protective Films)

While the first transparent protective film may be made of any material capable of providing a photoelastic coefficient in the above range, it is preferably made of a material having a high level of transparency, mechanical strength, thermal stability, water-blocking properties, and isotropy. Examples of materials of which the first transparent protective film is preferably made include cyclic polyolefin resins, acrylic resins, phenylmaleimide resins, cellulose resins, and modified polycarbonate resins.

Cyclic olefin resin is a generic name for resins produced by polymerization of cyclic olefin used as a polymerizable unit, and examples thereof include the resins disclosed in JP-A Nos. 01-240517, 03-14882, and 03-122137. Specific examples thereof include ring-opened (co)polymers of cyclic olefins, addition polymers of cyclic olefins, copolymers (typically random copolymers) of cyclic olefins and α-olefins such as ethylene and propylene, graft polymers produced by modification thereof with unsaturated carboxylic acids or derivatives thereof, and hydrides thereof. Examples of the cyclic olefin include norbornene monomers.

Examples of the norbornene monomers include norbornene and alkyl- and/or alkylidene-substituted products thereof. The norbornene resins may be used in combination with other ring-opening polymerizable cycloolefins, as long as the objects of the invention are not defeated.

Various commercially available cyclic polyolefin resins are placing on sale. Examples thereof include ZEONEX (trade name) and ZEONOR (trade name) series manufactured by Zeon Corporation, ARTON (trade name) series manufactured by JSR Corporation, TOPAS (trade name) series manufactured by Ticona, and APEL (trade name) series manufactured by Mitsui Chemicals, Inc.

Examples of the (meth)acrylic resin include poly(meth)acrylate such as poly(methyl methacrylate), methyl methacrylate-(meth)acrylic acid copolymers, methyl methacrylate-(meth)acrylate copolymers, methyl methacrylate-acrylate-(meth)acrylic acid copolymers, methyl (meth)acrylate-styrene copolymers (such as MS resins), and alicyclic hydrocarbon group-containing polymers (such as methyl methacrylate-cyclohexyl methacrylate copolymers and methyl methacrylate-norbornyl (meth)acrylate copolymers). Poly(C1-6 alkyl (meth)acrylate) such as poly(methyl (meth)acrylate) is preferred, and a methyl methacrylate-based resin mainly composed of a methyl methacrylate unit (50 to 100% by weight, preferably 70 to 100% by weight) is more preferred.

Examples of the (meth)acrylic resin include Acrypet VH and Acrypet VRL20A each manufactured by Mitsubishi Rayon Co., Ltd., (meth)acrylic resins having a ring structure in their molecule as disclosed in JP-A No. 2004-70296, and high-Tg (meth)acrylic resins produced by intramolecular crosslinking or intramolecular cyclization reaction.

Lactone ring structure-containing (meth)acrylic resins may also be used, because they have high heat resistance and high transparency and also have high mechanical strength after biaxially stretched.

Examples of the lactone ring structure-containing (meth)acrylic reins include the lactone ring structure-containing (meth)acrylic reins disclosed in JP-A Nos. 2000-230016, 2001-151814, 2002-120326, 2002-254544, and 2005-146084.

Phenylmaleimide resins include polymers of monomers having a maleimide group and a substituted or unsubstituted phenyl group bonded to the nitrogen atom of the maleimide group. Examples of raw material monomers for phenylmaleimide resins include N-phenylmaleimide, N-(2-methylphenyl)maleimide, N-(2-ethylphenyl)maleimide, N-(2-propylphenyl)maleimide, N-(2-isopropylphenyl)maleimide, N-(2,6-dimethylphenyl)maleimide, N-(2,6-dipropylphenyl)maleimide, N-(2,6-diisopropylphenyl)maleimide, N-(2-methyl-6-ethylphenyl)maleimide, N-(2-chlorophenyl)maleimide, N-(2,6-dichlorophenyl)maleimide, N-(2-bromophenyl)maleimide, N-(2,6-dibromophenyl)maleimide, N-(2-biphenyl)maleimide, and N-(2-cyanophenyl)maleimide. For example, such maleimide monomers are available from Tokyo Chemical Industry Co., Ltd.

Phenylmaleimide resins may also be copolymers of a phenylmaleimide monomer and any other monomer for improving brittleness, formability, heat resistance, or the like. Examples of other monomers used for such purposes include olefins such as ethylene, propylene, 1-butene, 1,3-butadiene, 2-methyl-1-butene, 2-methyl-1-pentene, and 1-hexene, acrylonitrile, methyl acrylate, methyl methacrylate, maleic anhydride, and vinyl acetate. For example, such phenylmaleimide-olefin copolymers are available from Tosoh Corporation.

The cellulose resin is an ester of cellulose and a fatty acid. Examples of such a cellulose ester resin include triacetyl cellulose, diacetyl cellulose, tripropionyl cellulose, dipropionyl cellulose, and the like. In particular, triacetyl cellulose is preferred.

Commercially available film including cellulose resin may be used. Examples of commercially available triacetyl cellulose film include UV-50, UV-80, SH-80, TD-80U, TD-TAC, and UZ-TAC (trade names) manufactured by Fujifilm Corporation, and KC series manufactured by Konica Minolta.

Examples of the modified polycarbonate resins include polymers that contain monomer units of 4,4′-(propane-2,2-diyl)diphenol (bisphenol A) as a bisphenol component and another bisphenol component for producing negative birefringence and therefore have a low photoelastic coefficient. For example, such a bisphenol component for forming the modified polycarbonate and producing negative birefringence may be a fluorene structure-containing bisphenol compound.

Examples of such modified polycarbonate resins that are preferably used include the polycarbonate resins disclosed in JP-A Nos. 2001-194530 and 2001-139676 and International Publication Nos. WO01/081959 and WO2006/041190.

Commercially available films containing modified polycarbonate resin may also be used. Examples of such modified polycarbonate films include Pureace WR (trade name) series manufactured by Teijin Chemicals LTD.

The first transparent protective film 2 may be an optically isotropic film having substantially no retardation or an optically anisotropic film having a certain retardation. Since the first transparent protective film 2 is placed between the image display cell 20 and the polarizer 1, it is preferably less uneven in retardation and has a high level of optical uniformity. When an optically anisotropic film is used as the first transparent protective film, the first transparent protective film may function as both a protective film for the polarizer and a retardation plate. For example, when the pressure-sensitive adhesive-type polarizing plate of the invention is used in a liquid crystal display device, the first protective film can also serve as an optical compensation film. When the pressure-sensitive adhesive-type polarizing plate of the invention is used in an organic EL display device, a quarter wavelength plate may be used as the first protective film to form a circularly polarizing plate.

While the thickness of the first transparent protective film may be determined as appropriate, it is generally from about 1 to about 500 μm, in particular, preferably from 5 to 200 μm, in view of strength, workability such as handleability, and thin film-forming ability.

When the pressure-sensitive adhesive-type polarizing plate has the second transparent protective film 3, the second protective film used is preferably, but not limited to, a transparent film having a high level of transparency, mechanical strength, thermal stability, and water-blocking properties. The exemplary materials shown above for use in forming the first protective film may also be used as materials for forming the second protective film.

The second transparent protective film surface to which no polarizer will be bonded may have undergone a treatment for hard coat layer formation, antireflection, anti-sticking, diffusion, or antiglare purpose. An antireflection layer, an anti-sticking layer, a diffusion layer, an antiglare layer, or the like may be formed in the transparent protective film itself or may be formed as another optical layer different from the transparent protective film.

The polarizer 1 and the transparent protective films 2 and 3 are preferably adhered with an adhesive. The adhesive is preferably a water-based adhesive or the like. Examples of the water-based adhesive include an isocyanate adhesive, a polyvinyl alcohol adhesive, a gelatin adhesive, a vinyl latex adhesive, an aqueous polyurethane adhesive, and an aqueous polyester adhesive. When the polarizer and the transparent protective film are bonded together, an activation treatment may be performed on the transparent protective film. Any of various methods such as saponification, corona treatment, low-pressure UV treatment, and plasma treatment may be used as the activation treatment.

### Pressure-Sensitive Adhesive Layer

The pressure-sensitive adhesive layer 5 is made of a pressure-sensitive adhesive. The base polymer used in the pressure-sensitive adhesive is an acryl-based polymer containing an alkyl (meth)acrylate monomer unit (component A) and an aromatic ring structure-containing (meth)acrylate monomer unit (component B). As used herein, the term “(meth)acrylate” means “acrylate and/or methacrylate.”

The content Y (%) of the aromatic ring structure-containing (meth)acrylate monomer unit (component B) in the acryl-based polymer as a base polymer satisfies the relation −1×10¹¹X+3≦Y≦−1×10¹¹X+23, wherein X represents the photoelastic coefficient (m²/N) of the first transparent protective film.

In an embodiment of the invention, the content Y of the component B is in the above range so that the absolute value of the change in the retardation of the pressure-sensitive adhesive-type polarizing plate can be small when the pressure-sensitive adhesive-type polarizing plate is exposed to a heating environment. The absolute value of the change in the retardation of the pressure-sensitive adhesive-type polarizing plate is preferably as small as possible. More specifically, the change in the retardation is preferably within ±2 nm, more preferably within ±1 nm.

Therefore, in order to reduce the change in the retardation of the pressure-sensitive adhesive-type polarizing plate and thus to suppress light leakage at an end portion of the screen of an image display device, the content Y (%) of the aromatic ring structure-containing (meth)acrylate monomer unit (component B) in the acryl-based polymer is preferably −1×10¹¹X+4 or more, more preferably −1×10¹¹X+5 or more, even more preferably −1×10¹¹X+6 or more. In addition, Y is preferably −1×10¹¹X+21 or less, more preferably −1×10¹¹X+20 or less, even more preferably −1×10¹¹X+19 or less. As described above, the content Y of the component B in the acryl-based polymer is controlled depending on the photoelastic coefficient X of the first transparent protective film, so that the photoelastic birefringence of the transparent protective film is cancelled by the birefringence of the pressure-sensitive adhesive layer, which makes it possible to reduce the change in the retardation of the whole of the pressure-sensitive adhesive-type polarizing plate. In addition, the absolute value of the photoelastic coefficient X (m²/N) of the first transparent protective film is preferably 30×10⁻¹² or less, more preferably 20×10⁻¹² or less, even more preferably 10×10⁻¹² or less.

In the alkyl (meth)acrylate (component A), the alkyl group may have about 1 to about 18 carbon atom(s), preferably 1 to 9 carbon atom(s) and may be any of a straight chain and a branched chain. Examples of the alkyl (meth)acrylate includes methyl (meth)acrylate, ethyl (meth)acrylate, propyl (meth)acrylate, isopropyl (meth)acrylate, n-butyl (meth)acrylate, isobutyl (meth)acrylate, pentyl (meth)acrylate, hexyl (meth)acrylate, 2-ethylhexyl (meth)acrylate, n-octyl (meth)acrylate, isooctyl (meth)acrylate, decyl (meth)acrylate, dodecyl (meth)acylate, lauryl (meth)acrylate, stearyl (meth)acrylate and so on. These may be used singly or in any combination. The average number of carbon atoms in these alkyl groups is preferably from 4 to 12.

The ring structure of the ring structure-containing (meth)acrylate (component B) may be a benzene ring, a naphthalene ring, a thiophene ring, a pyridine ring, a pyrrole ring, a furan ring and so on. Examples of the aromatic ring structure-containing (meth)acrylate include phenoxyethyl (meth)acrylate, benzyl (meth)acrylate, phenoxy-2-hydroxypropyl (meth)acrylate, phenol ethylene oxide-modified (meth)acrylate, 2-naphthoxyethyl (meth)acrylate, 2-(4-methoxy-1-naphthoxy)ethyl (meth)acrylate, phenoxypropyl (meth)acrylate, phenoxyethylene glycol (meth)acrylate, thiophenyl (meth)acrylate, pyridyl (meth)acrylate, pyrrolyl (meth)acrylate, phenyl (meth)acrylate, polystyryl (meth)acrylate and so on.

Although it is not clear why the change in the retardation can be reduced when the acryl-based polymer contains the specified amount of the aromatic ring structure-containing (meth)acrylate component (component B), it is considered that since the component B has, at the side chain, an aromatic ring structure with high polarizability, the tendency of the component B to produce birefringence should significantly differ from that of the alkyl (meth)acrylate component (component A).

The acryl-based polymer used to form the pressure-sensitive adhesive may further contain any other monomer unit (component C) in addition to the components A and B.

Examples of the component C include hydroxyl group-containing monomers such as 2-hydroxyethyl (meth)acrylate, 2-hydroxypropyl (meth)acrylate, 4-hydroxybutyl (meth)acrylate, 6-hydroxyhexyl (meth)acrylate, 8-hydroxyoctyl (meth)acrylate, 10-hydroxydecyl (meth)acrylate, 12-hydroxylauryl (meth)acrylate, and (4-hydroxymethylcyclohexyl)-methyl acrylate; carboxyl group-containing monomers such as include (meth)acrylic acid, carboxyethyl (meth)acrylate, carboxypentyl (meth)acrylate, itaconic acid, maleic acid, fumaric acid, and crotonic acid; acid anhydride group-containing monomers such as maleic anhydride and itaconic anhydride; caprolactone addition products of acrylic acid; sulfonic acid group-containing monomers such as styrenesulfonic acid, allylsulfonic acid, 2-(meth)acrylamido-2-methylpropanesulfonic acid, (meth)acrylamidopropanesulfonic acid, sulfopropyl (meth)acrylate, and (meth)acryloyloxynaphthalenesulfonic acid; and phosphate group-containing monomers such as 2-hydroxyethylacryloyl phosphate.

The component C may be derived from a nitrogen-containing vinyl monomer. Examples of such a monomer for modification include maleimide; (N-substituted) amide monomers such as (meth)acrylamide, N,N-dimethyl(meth)acrylamide, N,N-diethyl(meth)acrylamide, N-hexyl(meth)acrylamide, N-methyl(meth)acrylamide, N-butyl(meth)acrylamide, N-butyl(meth)acrylamide, N-methylol(meth)acrylamide, N-methylolpropane(meth)acrylamide; alkylaminoalkyl (meth)acrylate monomers such as aminoethyl (meth)acrylate, aminopropyl (meth)acrylate, N,N-dimethylaminoethyl (meth)acrylate, and tert-butylaminoethyl (meth)acrylate; alkoxyalkyl (meth)acrylate monomers such as methoxyethyl (meth)acrylate and ethoxyethyl (meth)acrylate; and succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide.

The component C may also be derived from vinyl monomers such as vinyl acetate, vinyl propionate, N-vinylcarboxylic acid amides, styrene, α-methylstyrene, and N-vinylcaprolactam; nitrile monomers such as acrylonitrile and methacrylonitrile; epoxy group-containing acrylic monomers such as glycidyl (meth)acrylate; glycol acrylate monomers such as polyethylene glycol (meth)acrylate, polypropylene glycol (meth)acrylate, methoxyethylene glycol (meth)acrylate, and methoxypolypropylene glycol (meth)acrylate; and (meth)acrylate monomers such as fluoro(meth)acrylate, silicone (meth)acrylate, and 2-methoxyethyl acrylate.

The component C may be used as appropriate in order to modify the base polymer. One or more types of the component C may be used. In the acrylic polymer, the percentage of the component C as a monomer unit is preferably 10% or less by weight, more preferably 6% or less by weight. When the percentage of the component C is more than 10% by weight, the pressure-sensitive adhesive can possibly lose flexibility.

The component C is preferably derived from a carboxyl group-containing monomer, particularly acrylic acid, in that the adhesion property thereof is good. The percentage of the component C derived from the carboxyl group-containing monomer may be from about 0.1 to about 10% by weight, preferably from 0.5 to 8% by weight, more preferably from 1 to 6% by weight. A hydroxyl group-containing monomer is also preferably used, because it can form a crosslinking point with an isocyanate crosslinking agent. The percentage of the component C derived from the hydroxyl group-containing monomer may be about from 0.1 to about 10% by weight, preferably from 0.5 to 8% by weight, more preferably from 1 to 6% by weight.

The acrylic polymer may be produced by a variety of known methods, for example, by a method appropriately selected from radical polymerization methods such as a bulk polymerization method, a solution polymerization method and a suspension polymerization method. A variety of known radical polymerization initiators such as azo initiators and peroxide initiators may be used. The reaction is generally performed at a temperature of about 50 to about 80° C. for a time period of 1 to 8 hours. Among the above production methods, the solution polymerization method is preferred, in which ethyl acetate, toluene or the like is generally used as a solvent for the acrylic polymer. The concentration of the solution is generally from about 20 to about 80% by weight. The acrylic polymer may be obtained in the form of an aqueous emulsion.

The weight average molecular weight of the acrylic polymer is from 1,000,000 to 3,000,000. The weight average molecular weight of the acrylic polymer is more preferably above 2,000,000 to 3,000,000, still more preferably from 2,100,000 to 2,700,000, rather than from 1,000,000 to 2,000,000. If the weight average molecular weight is too small, birefringence of the pressure-sensitive adhesive layer caused by the stress may not be large enough to cancel the birefringence of the transparent protective film, and light leakage of a liquid crystal display can occur. On the other hand, if the weight average molecular weight is more than 3,000,000, adhesion properties can be degraded.

The pressure-sensitive adhesive for forming the pressure-sensitive adhesive layer according to the present invention may include a crosslinking agent in addition to the acrylic polymer that is the base polymer. The crosslinking agent can improve adhesion to the optical film and durability and can achieve high temperature reliability or preserve the shape of the pressure-sensitive adhesive itself at high temperature. Any appropriate crosslinking agent may be used, such as an isocyanate type, epoxy type, peroxide type, metal chelate type, or oxazoline type crosslinking agent. One or more of these crosslinking agents may be used alone or in any combination. The present invention is preferably applied to the case where the peroxide is contained as the crosslinking agent. The crosslinking agent preferably contains a functional group reactive with a hydroxyl group, and an isocyanate crosslinking agent is particularly preferred.

The crosslinking agent may be used in an amount of 10 parts by weight or less, preferably of 0.01 to 5 parts by weight, more preferably of 0.02 to 3 parts by weight, based on 100 parts by weight of the acrylic polymer. The use of more than 10 parts by weight of the crosslinking agent can provide excessive crosslinkage to reduce the adhesion.

If necessary, the pressure-sensitive adhesive may conveniently contain various types of additives such as tackifiers, plasticizers, fillers comprising glass fibers, glass beads, metal power, or any other inorganic powder, pigments, colorants, fillers, antioxidants, ultraviolet absorbing agents, and silane coupling agents, without departing from the object of the present invention. The pressure-sensitive adhesive layer may also contain fine particles so as to have light diffusion properties.

The additive is preferably a silane coupling agent. Examples of the silane coupling agent include epoxy structure-containing silane coupling agents such as 3-glycidoxypropyltrimethoxysilane, 3-glycidoxypropylmethyldimethoxysilane, and 2-(3,4-epoxycyclohexyl)ethyltrimethoxysilane; amino group-containing silane coupling agents such as 3-aminopropyltrimethoxysilane, N-(2-aminoethyl)-3-aminopropyltrimethoxysilane, N-(2-aminoethyl)-3-aminopropylmethyldimethoxysilane, and 3-triethoxysilyl-N-(1,3-dimethylbutylidene)propylamine; (meth)acrylic group-containing silane coupling agents such as 3-acryloxypropyltrimethoxysilane and 3-methacryloxypropyltriethoxysilane; isocyanate group-containing silane coupling agents such as 3-isocyanatepropyltriethoxysilane; 3-chloropropyltrimethoxysilane; and acetoacetyl group-containing trimethoxysilane. The silane coupling agent may be used alone, or a mixture of two or more silane coupling agents may be used. The amount of the addition of the silane coupling agent may be from 0.01 to 2 parts by weight, preferably from 0.02 to 1 part by weight, based on 100 parts by weight of the acrylic polymer.

### Formation of Pressure-Sensitive Adhesive-Type Polarizing Plate

The pressure-sensitive adhesive-type polarizing plate 10 of the present invention can be produced by forming the pressure-sensitive adhesive layer formed from the pressure-sensitive adhesive onto transparent protective film 2. Examples of methods for forming the pressure-sensitive adhesive layer include, but are not limited to, a method including applying a pressure-sensitive adhesive solution onto the transparent protective film by any appropriate spreading method such as casting and coating, and drying it, and a method including forming the pressure-sensitive adhesive layer on a release sheet and transferring it from the release sheet. Coating methods that may be used include roll coating methods such as reverse coating and gravure coating and other coating methods such as spin coating methods, screen coating methods, fountain coating methods, dipping methods, and spray methods. After the pressure-sensitive adhesive solution is applied, the solvent and/or water may be evaporated by a drying step so that a pressure-sensitive adhesive layer with a desired thickness can be obtained.

The thickness of the pressure-sensitive adhesive layer may be appropriately determined depending on the application purpose, the adhesive strength or the like and is generally from 1 to 500 μm, preferably from 1 to 50 μm, more preferably from 1 to 40 μm, still more preferably from 5 to 30 μm, particularly preferably from 10 to 25 μm. A thickness of less than 1 μm can lead to poor durability. If it is too thick, peeling off or separation can tend to occur due to foaming or the like so that the appearance can tend to be poor.

The pressure-sensitive adhesive layer containing the acrylic polymer may also be formed by applying a UV-curable pressure-sensitive adhesive syrup to a release film and irradiating the syrup with radiation such as UV and electron beam. In this case, the pressure-sensitive adhesive may contain a crosslinking agent so that reliability or retention of the shape of the pressure-sensitive adhesive itself can be achieved at high temperature.

The pressure-sensitive adhesive layer may be crosslinked in the drying or UV irradiation step. Alternatively, another crosslinking mode may also be chosen, in which aging by warming state or standing at room temperature is performed so as to facilitate crosslinking after the drying.

The exposed surface of the pressure-sensitive adhesive layer 5 is preferably temporarily covered with a separator for antifouling or the like until it is put to use. This can prevent contact with the pressure-sensitive adhesive layer during usual handling. According to conventional techniques, appropriate separators may be used such as appropriate thin leaves including plastic films, rubber sheets, paper, cloth, nonwoven fabric, net, foam sheets, metal leafs, and laminates thereof, which are optionally coated with any appropriate release agent such as a silicone, long-chain alkyl or fluoride release agent, or molybdenum sulfide.

### Image Display Device

The pressure-sensitive adhesive-type polarizing plate of the invention is preferably used in various image display devices such as liquid crystal display devices and organic EL display devices. The image display device of the invention may have the same structure as conventional image display devices, except that it has the pressure-sensitive adhesive-type polarizing plate of the invention.

A liquid crystal display, for example, may be manufactured by properly assembling components such as a liquid crystal cell, optical elements such as polarizing plate of the present invention, and optionally a light system (such as a backlight) and so on, and incorporating a driving circuit and so on. Other constitutions in the liquid crystal display are not particularly limited, so long as the pressure-sensitive adhesive-type polarizing plate is used on one side or both sides of the liquid crystal cell.

In order to suppress light leakage of a liquid crystal display in which polarizers are placed on both viewer side and light source side of a liquid crystal cell, such as transparent-type liquid crystal display, the pressure-sensitive adhesive-type polarizing plates of the invention are preferably arranged on both sides of the liquid crystal cell.

An organic EL display may be manufactured by arranging the pressure-sensitive adhesive-type polarizing plate of the invention on a viewer side of an organic EL cell (organic luminescent layer). Specifically, when a quarter-wavelength plate is used as the first transparent protective film, lower visibility caused by a reflectance of external light may be prevented. In addition, a circular polarizer in which a quarter-wavelength plate other than the first transparent protective film is laminated with the polarizer of the invention may be arranged on the viewer side of the organic EL cell

The image displays of the present invention may be used for any appropriate use. For example, the image display may be used for OA equipment such as personal computer monitors, notebook computers, and copy machines; portable device such as cellular phones, watches, digital cameras, personal digital assistances (PDAs), and portable game machines; home appliance such as video cameras, televisions, and microwave ovens; vehicle equipment such as back monitors, monitors for car navigation systems, and car audios; display equipment such as information monitors for stores; alarm systems such as surveillance monitors; and care and medical device such as care monitors and medical monitors.

### EXAMPLES

The present invention is more specifically described with some examples below which are not intended to limit the scope of the present invention.

### Example 1

### Preparation of Pressure-Sensitive Adhesive

To a four-neck flask equipped with a cooling tube, a stirring blade and a thermometer were added 97 parts by weight of butyl acrylate, 3 parts by weight of benzyl acrylate, 0.1 parts by weight of 2,2′-azobisisobutyronitrile, and 140 parts by weight of ethyl acetate. After the air was sufficiently replaced with nitrogen, the mixture was allowed to react at 55° C. for 8 hours, while stirred under a nitrogen gas stream, so that a solution of acrylic polymers with a weight average molecular weight of 2,000,000 was obtained. Based on 100 parts by weight of the solids in the acrylic polymer solution, 0.45 parts by weight (in terms of solid) of a crosslinking agent (“Coronate L” (trade name) manufactured by Nippon Polyurethane Industry Co., Ltd.) and 0.1 parts by weight of a silane coupling agent (“KBM403” (trade name) manufactured by Shin-Etsu Silicone Co., Ltd.) were added to the acrylic polymer solution to produce a pressure-sensitive adhesive solution.

(Formation of Pressure-Sensitive Adhesive Layer)

The resulting pressure-sensitive adhesive solution was applied by reverse roll coating to a separator made of a release-treated polyester film (38 μm in thickness) such that the pressure-sensitive adhesive layer would have a thickness of 20 μm after drying, and then heated at 155° C. for 3 minutes for solvent vaporization so that a pressure-sensitive adhesive layer was obtained.

(Preparation of Polarizing Plates)

A polymer film composed mainly of polyvinyl alcohol with an average degree of polymerization of 2,400 and a degree of saponification of 99.9 mol % was stretched and fed, while it was dyed between rollers having different peripheral speeds, so that a polyvinyl alcohol-based polarizer was obtained. First, the polyvinyl alcohol film was stretched to 1.2 times in the feed direction, while it was allowed to swell by immersion in a water bath at 30° C. for 1 minute. Thereafter, the film was stretched in the feed direction to 3 times the original length of the unstretched film, while it was dyed by immersion in an aqueous solution at 30° C. containing 0.03% by weight of potassium iodide and 0.3% by weight of iodine for 1 minute. The film was then stretched to 6 times the original length in the feed direction, while it was immersed for 30 seconds in an aqueous solution at 60° C. containing 4% by weight of boric acid and 5% by weight of potassium iodide. The resulting stretched film was then dried at 70° C. for 2 minutes to give a polarizer. The polarizer had a thickness of 30 μm.

Modified poly(methyl methacrylate) resin films (“Fine Cast Film RZ-30NA-S” (trade name) manufactured by Toyo Kohan Co., Ltd., 1.5×10⁻¹² m²/N in photoelastic coefficient) were bonded to both surfaces of the resulting polarizer with a polyvinyl alcohol-based adhesive, so that a polarizing plate was obtained, in which the transparent protective films were placed on the polarizer.

(Preparation of Pressure-Sensitive Adhesive-Type Polarizer)

An undercoating agent was applied with a wire bar to the surface of the transparent protective film of the polarizing film to form an undercoat layer (100 nm in thickness). The undercoating agent used was a polyethyleneimine-based agent (“EPOMIN P-1000” (trade name) manufactured by Nippon Shokubai Co., Ltd.). The release sheet with the pressure-sensitive adhesive layer formed thereon was bonded to the undercoat layer so that a pressure-sensitive adhesive-type polarizer was prepared.

### Examples 2 and 3 and Comparative Examples 1 to 4

Pressure-sensitive adhesive-type polarizing plates were each prepared as in EXAMPLE 1, except that the pressure-sensitive adhesive solution was prepared with a different mixing ratio of butyl acrylate and benzyl acrylate from that in EXAMPLE 1.

### Examples 4 to 6 and Comparative Examples 5 to 8

Pressure-sensitive adhesive-type polarizing plates were each prepared as in EXAMPLE 1, except that the pressure-sensitive adhesive solutions were prepared with different mixing ratio of butyl acrylate and benzyl acrylate and that cyclic olefin resin films (“ZEONOR FILM ZB14-55124” (trade name) manufactured by Zeon Corporation, 4.0×10⁻¹² m²/N in photoelastic coefficient) were used as the transparent protective films in place of the modified poly(methyl methacrylate) resin films.

### Examples 7 to 9 and Comparative Examples 9 to 12

Pressure-sensitive adhesive-type polarizing plates were each prepared as in EXAMPLE 1, except that the pressure-sensitive adhesive solutions were prepared with different mixing ratio of butyl acrylate and benzyl acrylate and that triacetyl cellulose films (“FUJITAC TD80UL” (trade name) manufactured by Fujifilm Corporation, 16×10⁻¹² m²/N in photoelastic coefficient) were used as the transparent protective films in place of the modified poly(methyl methacrylate) resin films.

### Examples 10 to 12 and Comparative Examples 13 to 16

Pressure-sensitive adhesive-type polarizing plates were each prepared as in EXAMPLE 1, except that the pressure-sensitive adhesive solutions were prepared with different mixing ratio of butyl acrylate and benzyl acrylate and that triacetyl cellulose films (“KC4KR-1” (trade name) manufactured by Konica Minolta, 21.8×10⁻¹² m²/N in photoelastic coefficient) were used as the transparent protective films in place of the modified poly(methyl methacrylate) resin films.

### Examples 13 to 15 and Comparative Examples 17 to 20

Pressure-sensitive adhesive-type polarizing plates were each prepared as in EXAMPLE 1, except that the pressure-sensitive adhesive solutions were prepared with different mixing ratio of butyl acrylate and benzyl acrylate and that phenylmaleimide resin films (“TI-160α” (trade name) manufactured by Tosoh Corporation, −14×10⁻¹² m²/N in photoelastic coefficient) were used as the transparent protective films in place of the modified poly(methyl methacrylate) resin films.

### Examples 16 to 18 and Comparative Examples 21 to 24

Pressure-sensitive adhesive-type polarizing plates were each prepared as in EXAMPLE 1, except that the pressure-sensitive adhesive solutions were prepared with different mixing ratio of butyl acrylate and benzyl acrylate and that modified polycarbonate resin films (“Pureace WR” (trade name) manufactured by Teijin Chemicals LTD., −30×10⁻¹² m²/N in photoelastic coefficient) were used as the transparent protective films in place of the modified poly(methyl methacrylate) resin films.

### Preparation of Liquid Crystal Panel

A liquid crystal panel was taken out of a liquid crystal television (BRAVIA (trade name) manufactured by Sony Corporation) having a VA- and IPS-mode liquid crystal cell. Polarizing plates placed on the upper and lower sides of the liquid crystal cell were removed, and the glass surfaces (front and back) of the liquid crystal cell were washed. Subsequently, the pressure-sensitive adhesive-type polarizing plates prepared in each of the EXAMPLEs and the COMPARATIVE EXAMPLEs were bonded to both surfaces of the liquid crystal cell.

### Evaluation

### (Measurement of the Brightness of the Center and Corners of the Screen)

The liquid crystal panel in which the pressure-sensitive adhesive-type polarizing plates prepared in each of the EXAMPLEs and the COMPARATIVE EXAMPLEs were bonded was placed in an air circulation type thermostatic chamber at 95° C. for 24 hours. Thereafter, the liquid crystal panel was taken out and placed on a backlight with a brightness of 10,000 cd/m², and while black was displayed on the liquid crystal panel, the brightness of the center and corners (four corners) of the screen was measured in the normal direction with a brightness meter (BM-5A (trade name) manufactured by Topcon Corporation).

### (Measurement of Variations in In-Plane Brightness)

Before and after the liquid crystal panel was placed in the air circulation type thermostatic chamber at 95° C. for 24 hours, the liquid crystal panel was placed on a backlight with a brightness of 10,000 cd/m² and subjected to the measurement of the in-plane brightness of the screen with an in-plane brightness analyzer (EyeScale-4W (trade name) manufactured by I System Corporation), while black was displayed on the screen.

Table 1 shows the results of the measurement of the brightness together with the composition of the pressure-sensitive adhesive of the pressure-sensitive adhesive-type polarizing plate and the photoelastic coefficient of the transparent protective film in each of the EXAMPLEs and the COMPARATIVE EXAMPLEs. In Table 1, X represents the photoelastic coefficient of the transparent protective film, and Y represents the content (% by weight) of the aromatic ring structure-containing (meth)acrylate monomer unit in the acryl-based polymer, which forms the pressure-sensitive adhesive. The corner brightness is the average of the brightness at the four corners of the screen, and the “brightness difference” indicates the difference between the brightness of the center of the screen and the corner brightness. In Table 1, Δσ represents the difference between the dispersion σ₀ₕ of the in-plane brightness before the high-temperature test and the dispersion σ₂₄ₕ of the in-plane brightness after the high-temperature test (Δσ=σ₂₄ₕ−σ₀ₕ).

TABLE 1

| | X | Y | Brightness (cd/m²) | | | |
|---|---|---|---|---|---|---|
| | (x10⁻¹²m²/N) | (wt %) | center | corner | difference | Δσ |
| COMPARATIVE EXAMPLE 1 | 1.5 | 0.0 | 0.08 | 1.25 | 1.17 | 0.088 |
| EXAMPLE 1 | 1.5 | 5.0 | 0.07 | 0.45 | 0.38 | 0.032 |
| EXAMPLE 2 | 1.5 | 13.4 | 0.05 | 0.10 | 0.05 | 0.004 |
| EXAMPLE 3 | 1.5 | 20.0 | 0.06 | 0.49 | 0.43 | 0.036 |
| COMPARATIVE EXAMPLE 2 | 1.5 | 26.0 | 0.06 | 1.70 | 1.64 | 0.095 |
| COMPARATIVE EXAMPLE 3 | 1.5 | 38.0 | 0.07 | 3.66 | 3.59 | 0.366 |
| COMPARATIVE EXAMPLE 4 | 1.5 | 49.3 | 0.08 | 9.11 | 9.03 | 1.149 |
| COMPARATIVE EXAMPLE 5 | 4.0 | 0.0 | 0.05 | 1.12 | 1.07 | 0.092 |
| EXAMPLE 4 | 4.0 | 5.0 | 0.07 | 0.53 | 0.46 | 0.039 |
| EXAMPLE 5 | 4.0 | 13.4 | 0.08 | 0.17 | 0.09 | 0.007 |
| EXAMPLE 6 | 4.0 | 20.0 | 0.04 | 0.48 | 0.44 | 0.034 |
| COMPARATIVE EXAMPLE 6 | 4.0 | 26.0 | 0.05 | 1.25 | 1.20 | 0.104 |
| COMPARATIVE EXAMPLE 7 | 4.0 | 38.0 | 0.08 | 4.32 | 4.24 | 0.442 |
| COMPARATIVE EXAMPLE 8 | 4.0 | 49.3 | 0.09 | 9.03 | 8.94 | 1.121 |
| COMPARATIVE EXAMPLE 9 | 16.0 | 0.0 | 0.09 | 0.98 | 0.89 | 0.077 |
| EXAMPLE 7 | 16.0 | 5.0 | 0.04 | 0.40 | 0.36 | 0.031 |
| EXAMPLE 8 | 16.0 | 13.4 | 0.06 | 0.21 | 0.15 | 0.012 |
| EXAMPLE 9 | 16.0 | 20.0 | 0.08 | 0.55 | 0.47 | 0.037 |
| COMPARATIVE EXAMPLE 10 | 16.0 | 26.0 | 0.07 | 1.49 | 1.42 | 0.125 |
| COMPARATIVE EXAMPLE 11 | 16.0 | 38.0 | 0.08 | 4.73 | 4.65 | 0.495 |
| COMPARATIVE EXAMPLE 12 | 16.0 | 49.3 | 0.06 | 9.61 | 9.55 | 1.297 |
| COMPARATIVE EXAMPLE 13 | 21.8 | 0.0 | 0.05 | 0.86 | 0.81 | 0.069 |
| EXAMPLE 10 | 21.8 | 5.0 | 0.06 | 0.38 | 0.32 | 0.028 |
| EXAMPLE 11 | 21.8 | 13.4 | 0.08 | 0.19 | 0.11 | 0.009 |
| EXAMPLE 12 | 21.8 | 20.0 | 0.09 | 0.57 | 0.48 | 0.041 |
| COMPARATIVE EXAMPLE 14 | 21.8 | 26.0 | 0.07 | 1.60 | 1.53 | 0.138 |
| COMPARATIVE EXAMPLE 15 | 21.8 | 38.0 | 0.08 | 4.94 | 4.86 | 0.543 |
| COMPARATIVE EXAMPLE 16 | 21.8 | 49.3 | 0.07 | 9.92 | 9.85 | 1.344 |
| COMPARATIVE EXAMPLE 17 | −14.0 | 0.0 | 0.09 | 1.47 | 1.38 | 0.121 |
| EXAMPLE 13 | −14.0 | 5.0 | 0.07 | 0.56 | 0.49 | 0.043 |
| EXAMPLE 14 | −14.0 | 13.4 | 0.06 | 0.24 | 0.18 | 0.016 |
| EXAMPLE 15 | −14.0 | 20.0 | 0.07 | 0.38 | 0.31 | 0.025 |
| COMPARATIVE EXAMPLE 18 | −14.0 | 26.0 | 0.08 | 0.61 | 0.53 | 0.051 |
| COMPARATIVE EXAMPLE 19 | −14.0 | 38.0 | 0.09 | 3.75 | 3.66 | 0.340 |
| COMPARATIVE EXAMPLE 20 | −14.0 | 49.3 | 0.08 | 8.15 | 8.07 | 1.034 |
| COMPARATIVE EXAMPLE 21 | −30.0 | 0.0 | 0.08 | 1.77 | 1.69 | 0.152 |
| COMPARATIVE EXAMPLE 22 | −30.0 | 5.0 | 0.07 | 0.59 | 0.52 | 0.052 |
| EXAMPLE 16 | −30.0 | 13.4 | 0.07 | 0.26 | 0.19 | 0.016 |
| EXAMPLE 17 | −30.0 | 20.0 | 0.06 | 0.29 | 0.23 | 0.019 |
| EXAMPLE 18 | −30.0 | 26.0 | 0.09 | 0.59 | 0.50 | 0.044 |
| COMPARATIVE EXAMPLE 23 | −30.0 | 38.0 | 0.05 | 3.22 | 3.17 | 0.311 |
| COMPARATIVE EXAMPLE 24 | −30.0 | 49.3 | 0.06 | 7.40 | 7.34 | 0.891 |

Table 1 shows that in the liquid crystal display device produced with the pressure-sensitive adhesive-type polarizing plate of each EXAMPLE, the brightness difference between the center and the corner of the screen is relatively small with a reduced change in the dispersion of the in-plane brightness before and after the heating test. Therefore, it is apparent that liquid crystal display devices produced with the pressure-sensitive adhesive-type polarizing plate of the invention are less likely to suffer from light leakage and to change in brightness when exposed to a change in usage environment.

1. A polarizing plate having pressure-sensitive adhesive layer, comprising:
a polarizer;
a transparent protective film placed on at least one surface of the polarizer; and
a pressure-sensitive adhesive layer placed on a surface of the transparent protective film on a side where the polarizer is not placed, wherein
the pressure-sensitive adhesive layer comprises a pressure-sensitive adhesive comprising an acryl-based polymer comprising an alkyl (meth)acrylate monomer unit and an aromatic ring structure-containing (meth)acrylate monomer unit,
the transparent protective film has an absolute value of photoelastic coefficient of 14×10⁻¹² to 50×10⁻¹² (m²/N), and
X and Y satisfy the relation −1×10¹¹X+3≦Y≦−1×10¹¹X+23,
wherein X represents the photoelastic coefficient (m²/N) of the transparent protective film, and Y represents the content (%) of the aromatic ring structure-containing (meth)acrylate monomer unit in the acryl-based polymer.

2. The polarizing plate according to claim 1, wherein the transparent protective film comprises at least one resin selected from the group consisting of an acrylic resin, a cyclic olefin resin, a phenylmaleimide resin, a cellulose resin, and a modified polycarbonate resin.

3. An image display device comprising the polarizing plate according to claim 1.
